(19) United States
(12) Patent Application Publication
(10) Pub. No.: US 2009/0226032 A1
(43) Pub. Date: Sep. 10, 2009

(54) SYSTEMS AND METHODS FOR REDUCING FALSE ALARMS IN DETECTION SYSTEMS

(76) Inventors: Matthew Allen Merzbacher, Oakland, CA (US); Todd Gable, Newark, CA (US); Gregory Lewis Orr, Fremont, CA (US)

Correspondence Address: General Electric Company;GE Global Patent Operation, PO Box 861, 2 Corporate Drive, Suite 648, Shelton, CT, 06484, US

(21) Appl. No.: 11/863,851

(22) Filed: Sep. 28, 2007

(51) Int. Cl. G06K 9/00; G06K 9/62

(52) U.S. Cl. 382/103; 382/224; 382/190

(57) ABSTRACT

Systems and methods for classifying targets within a container are provided. In one aspect, a method for resolving an alarm raised by an imaging system that includes a component for detecting contraband objects in a container is provided. The method includes receiving a plurality of images from the imaging system, calculating at least one feature for at least one object that caused the alarm, inputting the at least one feature into at least one classifier, rendering a decision about the at least one object based on a vote of the at least one classifier, and rendering a final decision about the container.

### FIELD OF THE INVENTION

The systems and methods described herein relate generally to post-detection classification systems and, more particularly, to separating false alarms from true alarms using statistics and probability.

### BACKGROUND OF THE INVENTION

Since the events of Sep. 11, 2001, the Department of Homeland Security has increased security dramatically in U.S. airports. Such security efforts include screening passengers and carry-on bags and luggage for contraband including explosive materials.

At least some known security scanning systems employ X-ray transmission technology. Although these systems enable the detection of weapons and blades, for example, they lack the capability of detecting explosives with a low false alarm rate.

For example, computed tomography (CT) provides a quantitative measure of material characteristics, regardless of location or the superposition of objects, and a substantial advantage over conventional and multi-view X-ray transmission and radioisotope-based imaging systems. In a CT scanner, a large number of precise X-ray “views” are obtained at multiple angles. These views are then used to reconstruct planar or volumetric images. The image is a mapping of the X-ray mass attenuation value for each volume element (or voxel) within the imaged volume.

Systems employing, for example, CT scanners are used widely in airports around the world on checked luggage to detect explosives that pose a threat to aviation safety. These systems employ an X-ray source and opposing detectors that detect X-ray radiation that passes through an object, e.g., a suitcase, as the container is translated along a horizontal axis.

At least some known scanning systems are capable of detecting most explosives and other contraband. However, false alarms are occasionally raised due to similarities shared by explosives and other contraband and benign materials. There is a need for a system that can differentiate between false alarms and true alarms.

### BRIEF DESCRIPTION OF THE INVENTION

In one aspect, a method for resolving an alarm raised by an imaging system that includes a component for detecting contraband objects in a container is provided. The method includes receiving a plurality of images from the imaging system, calculating at least one feature for at least one object that caused the alarm, inputting the at least one feature into at least one classifier, rendering a decision about the at least one object based on a vote of the at least one classifier, and rendering a final decision about the container.

In another aspect, a post-detection processing system for use with an imaging system is provided, wherein the imaging system includes a detection component configured to alarm at a detection of suspected contraband within a container being scanned. The post-detection processing system is configured to separate false alarms from actual detections. The post-detection processing system includes a memory electrically connected to a system bus and at least one processor electrically coupled to the system bus and communicatively coupled to the memory via the system bus. The post-detection processing system is configured to receive a plurality of images from the imaging system, wherein each image of the plurality of images includes a plurality of image elements, store the received images in the memory, calculate a plurality of features from a subset of the plurality of image elements, wherein the subset corresponds to at least one object having triggered an alarm by the imaging system, input the plurality of features to a plurality of classifiers, and determine an alarm status for each alarm triggered by the at least one object based on a vote by each classifier of the plurality of classifiers.

In another aspect, a post-detection classification system for separating false alarms from true alarms by an imaging system is provided, wherein an alarm is raised by the imaging system during a scan of a container. The post-detection classification system includes at least one classifier configured to determine and issue a vote on a status of the alarm based on at least one calculated feature of a plurality of image elements within a plurality of images received from the imaging system. The at least one classifier is constructed by collecting a test set including a true alarm subset and a false alarm subset, calculating a first performance of the at least one classifier using the test set, determining at least one of a range and a standard deviation for a plurality of features of the test set, increasing a perturbation factor, modifying a value of at least one feature of the plurality of features in the test set, and calculating a second performance of the at least one classifier using the modified test set values.

### BRIEF DESCRIPTION OF THE DRAWINGS

FIGS. 1-3 show exemplary embodiments of the systems and methods described herein. The embodiments shown in FIGS. 1-3 and described by reference to FIGS. 1-3 are exemplary only.

FIG. 1 is a block diagram of an exemplary post-detection classification system;

FIG. 2 shows a flow chart for an exemplary method for creating a classifier that may be used with the post-detection classification system shown in FIG. 1; and

FIG. 3 shows a flow chart for an exemplary method for processing an alarm using the post-detection classification system shown in FIG. 1.

### DETAILED DESCRIPTION OF THE INVENTION

The embodiments described herein provide systems and methods for effectively processing the output of an imaging system that includes a detection and/or alarm component, and separating false alarms raised by the component from true alarms raised by the component. In one embodiment, a post-detection classification system receives images from an imaging system, each image consisting of a plurality of image elements, such as pixels or voxels. Using the image elements that make up the images, the post-detection classification system calculates one or more features for an object causing an alarm. The one or more features are input into one or more classifiers, which render a decision on the object based on a vote. The post-detection classification system then renders a final decision on the container.

Moreover, the embodiments described herein provide technical effects such as, but not limited to, reducing the occurrence of false alarms by using a set of image features and knowledge discovery techniques to separate false alarms from true alarms on a probabilistic basis. The image features include, but are not limited to, statistical features, information theoretical values, and/or textural features. The image features are then used as input to a series of inductive learning systems trained to vote on the nature of the alarm. Alarms receiving a sufficient number of votes are identified as false alarms.

At least one embodiment of the present invention is described below in reference to its application in connection with and operation of a system for inspecting cargo. However, it should be apparent to those skilled in the art and guided by the teachings herein provided that the invention is likewise applicable to any suitable system for scanning cargo containers including, without limitation, boxes, drums, and luggage, transported by water, land, and/or air, as well as other containers and/or objects.

Moreover, although embodiments of the present invention are described below in reference to its application in connection with and operation of a system incorporating an X-ray computed tomography (CT) scanning system for inspecting cargo, it should be apparent to those skilled in the art and guided by the teachings herein provided that any suitable radiation source including, without limitation, neutrons or gamma rays, may be used in alternative embodiments. Further, it should be apparent to those skilled in the art and guided by the teachings herein provided that any scanning system may be used that produces a sufficient number of pixels to enable the functionality of the post-detection classification system described herein.

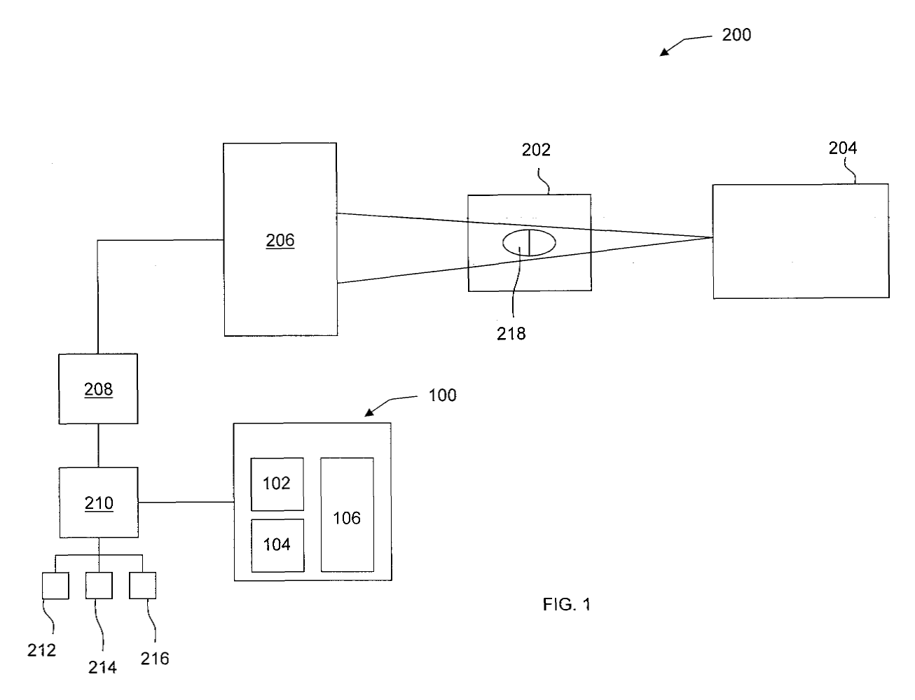

FIG. 1 is a block diagram of an exemplary embodiment of a post-detection classification system 100. In one embodiment, system 100 is used with an X-ray computed tomography (CT) scanning system 200 for scanning a container 202, such as a cargo container, box, or parcel, to identify the contents and/or determine the type of material contained within container 202. The term “contents” as used herein generally refers to any object and/or material contained within container 202 and may include contraband.

In one embodiment, scanning system 200 includes at least one X-ray source 204 configured to transmit at least one beam of radiation through container 202. In an alternative embodiment, scanning system 200 includes a plurality of X-ray sources 204 configured to emit radiation of different energy distributions. Alternatively, each X-ray source 204 is configured to emit radiation of selective energy distributions, which can be emitted at different times. In a particular embodiment, scanning system 200 utilizes multiple-energy scanning to obtain an attenuation map for container 202. In addition to the production of CT images, multiple-energy scanning enables the production of density maps and atomic number(s) of the object contents. In one embodiment, the dual energy scanning of container 202 includes inspecting container 202 by scanning container 202 at a low energy and then scanning container 202 at a high energy. The data is collected for the low-energy scan and the high-energy scan to reconstruct the CT, density and/or atomic number images of container 202 to facilitate identifying the type of material or contraband within container 202 based on the material content of container 202, as described in greater detail below.

In one embodiment, scanning system 200 also includes at least one X-ray detector 206 configured to detect radiation emitted from X-ray source 204 and transmitted through container 202. X-ray detector 206 is configured to cover an entire field of view or only a portion of the field of view. Upon detection of the transmitted radiation, X-ray detector 206 generates a signal representative of the detected transmitted radiation. The signal is transmitted to a data collection system and/or processor as described below. The signal is transmitted to a data collection system and/or processor as described below. Scanning system 200 is utilized to reconstruct a CT image of container 202 in real time, non-real time, or delayed time.

In one embodiment of scanning system 200, a data collection system 208 is operatively coupled to and in signal communication with X-ray detector 206. Data collection system 208 is configured to receive the signals generated and transmitted by X-ray detector 206. A processor 210 is operatively coupled to data collection system 208. Processor 210 is configured to produce or generate an image of container 202 and its contents and process the produced image to facilitate determining the material content of container 202. More specifically, in one embodiment data collection system 208 and/or processor 210 produces at least one attenuation map based upon the signals received from X-ray detector 206. Utilizing the attenuation map(s), at least one image of the contents is reconstructed and a CT number, a density and/or an atomic number of the contents is inferred from the reconstructed image(s). Based on these CT images, density and/or atomic maps of the cargo can be produced. The CT images, the density and/or atomic number images are analyzed to infer the presence of contraband, such as, but not limited to, explosives.

In alternative embodiments of scanning system 200, one processor 210 or more than one processor 210 may be used to generate and/or process the container image. One embodiment of scanning system 200 also includes a display device 212, a memory device 214 and/or an input device 216 operatively coupled to data collection system 208 and/or processor 210.

During operation of an embodiment of scanning system 200, X-ray source 204 emits X-rays in an energy range, which is dependent on a voltage applied by a power source to X-ray source 204. A primary beam is generated and passes through container 202, and X-ray detector 206, positioned on the opposing side of container 202, measures an intensity of the primary beam.

Alarms raised by scanning system 200 for suspected contraband are then processed by post-detection classification system 100 using a set of image element features and knowledge discovery techniques to facilitate separating false alarms from true alarms on a probabilistic basis. In one embodiment, two-dimensional image pixels are used to calculate the image features. In an alternative embodiment, three-dimensional image voxels are used to calculate the image features.

In the exemplary embodiment, the image features include, but are not limited to, statistical features, information theoretical values, and/or textural features. Examples of statistical features include, but are not limited to, mean, median, standard deviation, skew, and/or kurtosis. An example of an information theoretical value is entropy. An example of a textural feature is wavelets. Alternative embodiments of post-detection classification system 100 utilize features different than and/or in addition to these examples. For example, post-detection classification system 100 calculates the standard deviation of the CT values of the set of voxels that makes up object 128 that raised an alarm in scanning system 200. As another example, post-detection classification system 100 calculates the mean of the CT values of the set of voxels that makes up object 128 that raised an alarm in scanning system 200. The image features are then used as input into a plurality of inductive learning systems, or classifiers, which are trained to vote on the nature of an alarm such that an alarm receiving a sufficient number of votes by the classifiers is identified as a false alarm.

In the exemplary embodiment, post-detection classification system 100 includes one or more processors 102 electrically coupled to a system bus (not shown). System 100 also includes a memory 104 electrically coupled to the system bus such that memory 104 is communicatively coupled to processor 102. As used herein, the term processor is not limited to only integrated circuits referred to in the art as a processor, but broadly refers to a computer, a microcontroller, a microcomputer, a programmable logic controller, an application specific integrated circuit and any other programmable circuit. The processor may also include a storage device and/or an input device, such as a mouse and/or a keyboard.

In addition, system 100 includes one or more classifiers 106. In the exemplary embodiment, system 100 includes multiple classifiers using different learning systems. One such learning system is a classification tree. Each node of the classification tree is assigned a value and is split into two child nodes. To predict a category of a target variable, such as material density, using a classification tree, the variable value is used to move through the tree until reaching a terminal node. Another learning system that may be used to build a classifier is Fisher discriminant, which finds the linear combination of features which best separate two or more classes of objects. Yet another example of a learning system that may be used to build a classifier is a neural net. In one embodiment, learning systems such as the above-described learning systems are used to build the plurality of classifiers used in system 100. In an alternative embodiment, learning systems other than the above-described learning systems are used. In a further alternative embodiment, the above-described learning systems, including multiple versions of the above-described learning systems, and learning systems other than those describe above are included in the plurality of classifiers used in system 100.

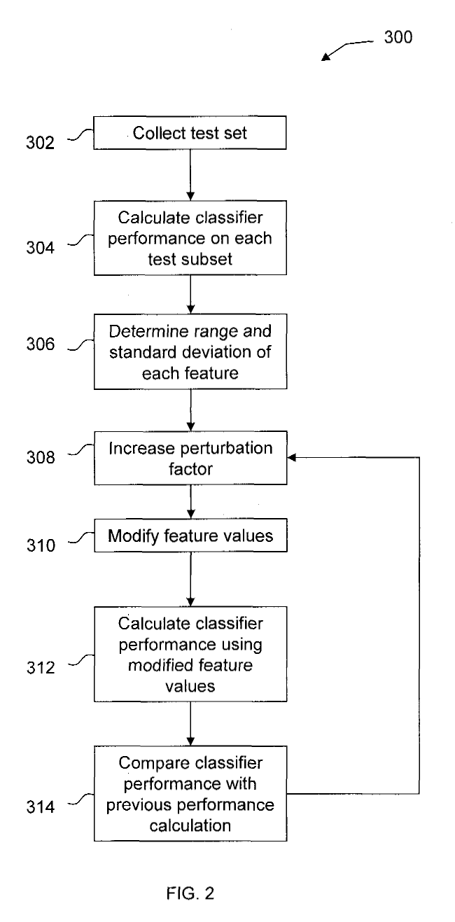

FIG. 2 shows a flow chart illustrating a method 300 for creating classifier 106 (shown in FIG. 1) that may be used with post-detection classification system 100 (shown in FIG. 1). In the exemplary embodiment, a test set is collected 302. The test set is collected 302 from a number of sources or is created manually. The test set includes, for example, X-ray images of containers that have only non-contraband items, X-ray images of containers that have both contraband and non-contraband items, and X-ray images of containers that have only contraband items. Additionally, data may be collected 302 from real-world X-ray images collected from, for example, travel hubs such as airports and/or train depots. In the exemplary embodiment, the test set includes two subsets. One subset includes true alarms and an associated series of calculated features. A second subset includes false alarms and another series of calculated features.

Moreover, in the exemplary embodiment, the performance of each classifier 106 is calculated 304. During performance testing, each test subset is input into each classifier 106 and, for each classifier 106, two values are generated. One value is a percent of true alarms retained, P_{D}. Another value is a percent of false alarms retained, P_{FA}. The first performance test of classifiers 106 serves to generate a baseline for comparing later test results. In the exemplary embodiment, after the performance of each classifier 106 is calculated 304, a range and standard deviation are calculated 306 for each feature.

In the exemplary embodiment, a perturbation factor is then increased 308 by a predetermined amount. A perturbation factor, as used herein, is a known measure of change applied to the test set data. In the exemplary embodiment, after increasing 308 the perturbation factor, the feature values for each alarm of both test subsets are modified 310 using the perturbation factor. In one embodiment, the values are modified 310 by a random amount. In an alternative embodiment, the values of each feature are modified 310 by a random amount that is between zero and a second value equal to the perturbation factor as set in step 308 multiplied by the calculated 306 standard deviation for each feature. In another alternative embodiment, the feature values are not modified 310 for all features. In yet another alternative embodiment, the values of each feature are modified 310 by different amounts. In still another alternative embodiment, the values of each feature are bounded such that a modification 310 that results in an out of bounds value results in a value equal to or just within the boundary value. In the exemplary embodiment, after the feature values are modified 310, the performance of each classifier 106 is re-calculated 312 and compared 314 with a previously calculated performance. Steps 308, 310, 312, and 314 are repeated to determine a robustness of classifiers 106.

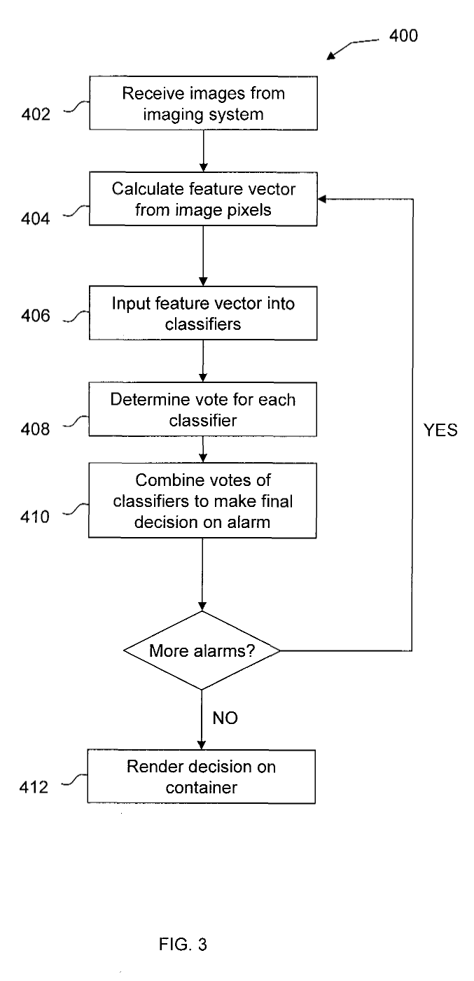

FIG. 3 shows a flow chart illustrating a method 400 for classifying object 218 (shown in FIG. 1) within container 202 (shown in FIG. 1) as either a true alarm or a false alarm using post-detection classification system 100 (shown in FIG. 1). In the exemplary embodiment, post-detection classification system 100 receives 402 a plurality of images from scanning system 200 (shown in FIG. 1). In one embodiment, system 100 receives 402 the plurality of images automatically when an alarm is triggered. In an alternative embodiment, a user of system 200 requests a decision on a triggered alarm and system 200 provides system 100 with the plurality of images. For each image, system 100 calculates 404 a vector of features from a plurality of image elements making up each image, such as pixels or voxels. More specifically, system 100 calculates 404 a series of features, such as those described above, using the image elements associated with each object 218 that triggered an alarm by system 200.

In the exemplary embodiment, the feature vector is input 406 into classifiers 106 (shown in FIG. 1). Each classifier 106 uses one or more of the features in the feature vector to determine 408 a vote on the alarm. More specifically, each classifier 106 uses the learning system with which classifier 106 has been built to determine 408 whether classifier 106 votes the alarm as a true alarm or a false alarm. In one embodiment, the vote provided by classifier 106 is a yes-no or true-false vote. In an alternative embodiment, the vote provided by classifier 106 is a weighted value. In another alternative embodiment, the vote provided by classifier 106 is a probability.

In the exemplary embodiment, the provided votes from each classifier 106 are combined 410 to make a final decision on the alarm. Specifically, the votes of each of classifiers 106 are tabulated to determine whether system 100 declares the alarm a true alarm or a false alarm. In one embodiment, the combination 410 of the classifier votes is user-tunable. In such a case, system 100 identifies an alarm as a false alarm only if all classifier votes agree or, alternatively, identifies an alarm as a true alarm only if all classifier votes agree. In an alternative embodiment, system 100 identifies an alarm as a false alarm or, alternatively, as a true alarm, based on as few as one classifier vote. In the exemplary embodiment, steps 404, 406, 408, and 410 are repeated for each object 218 within container 202 that triggers an alarm by system 200.

In the exemplary embodiment, after all alarms are determined to be true alarms or false alarms, system 100 renders 412 a decision on container 202. If all alarms are determined to be false alarms, container 202 is cleared. On the other hand, if any alarms are determined to be true alarms, container 202 is subjected to further inspection, such as manual inspection. In an alternative embodiment, clearing container 202 does not require all alarms to be determined to be false alarms.

In summary, in one embodiment, a method for resolving alarms raised by an imaging system that includes a component for detecting contraband in a container is provided. The method includes receiving a plurality of images from the imaging system and calculating at least one feature for at least one object causing an alarm. In an alternative embodiment, calculating a feature for the object is accomplished using a plurality of image elements associated with the object.

Moreover, the method includes inputting the feature into at least one classifier and rendering a decision on the object based on a vote of the classifier. In an alternative embodiment, rendering a decision on the object is based on a minimum number of classifier votes. As such, the method also includes determining, by the classifier, a vote as to whether the object is a true alarm or a false alarm using the calculated feature. The vote is one of a true-false choice, a weighted value, and a probability. In another alternative embodiment, when the vote is a weighted value, rendering a decision on the object also includes processing the weighted value.

In addition, the method includes rendering a final decision on the container based on a minimum number of cleared objects having raised alarms during a scan of the container by the imaging system.

The above-described systems and methods facilitate inspecting cargo containers efficiently and reliably. More specifically, the systems and methods facilitate effectively processing the output of an imaging system that includes a detection and/or alarm component, and separating false alarms raised by the component from true alarms raised by the component. Use of multiple classifiers to determine the truth of an alarm facilitates increasing the certainty of the classification of each object. Moreover, use of different classification methods facilitates further increasing the certainty of the classification of each object and each target. Determining the truth of an alarm facilitates reducing the number of manual inspections that must be completed, thereby reducing the need for inspection personnel and/or reducing time spent by passengers in security lines.

Exemplary embodiments of a system and method for inspecting cargo are described above in detail. The system and method are not limited to the specific embodiments described herein, but rather, components of the system and/or the steps of the method may be utilized independently and separately from other components and/or steps described herein. Further, the described system components and/or method steps can also be defined in, or used in combination with, other systems and/or methods, and are not limited to practice with only the system and method as described herein.

While the above-described systems and methods have been described in terms of various specific embodiments, those skilled in the art will recognize that the invention can be practiced with modification within the spirit and scope of the claims.

1. A method for resolving an alarm raised by an imaging system that includes a component for detecting contraband objects in a container, said method comprising:
receiving a plurality of images from the imaging system;
calculating at least one feature for at least one object that caused the alarm;
inputting the at least one feature into at least one classifier;
rendering a decision about the at least one object based on a vote of the at least one classifier; and
rendering a final decision about the container.

2. A method in accordance with claim 1 wherein the step of calculating further comprises using a plurality of image elements associated with the at least one object.

3. A method in accordance with claim 1 further comprising determining, by the at least one classifier, a vote whether the at least one object is one of a true alarm and a false alarm using the at least one calculated feature, wherein the vote is one of a true-false choice, a weighted value, and a probability.

4. A method in accordance with claim 3 further comprising processing the weighted value when the vote is a weighted value.

5. A method in accordance with claim 1 wherein the step of rendering a decision further comprises rendering a decision based on a minimum number of classifier votes.

6. A method in accordance with claim 1 wherein the step of rendering a final decision further comprises rendering a final decision based on a minimum number of cleared objects having raised alarms during a scan of the container by the imaging system.

7. A post-detection processing system for use with an imaging system comprising a detection component configured to alarm at a detection of suspected contraband within a container being scanned, said post-detection processing system configured to separate false alarms from actual detections, said post-detection processing system comprising:
a memory electrically connected to a system bus; and
at least one processor electrically coupled to said system bus, said at least one processor communicatively coupled to said memory via said system bus, said post-detection processing system configured to:
receive a plurality of images from the imaging system, wherein each image of the plurality of images comprises a plurality of image elements;
store the received images in said memory;
calculate a plurality of features from a subset of the plurality of image elements, wherein the subset corresponds to at least one object having triggered an alarm by the imaging system;
input the plurality of features to a plurality of classifiers; and
determine an alarm status for each alarm triggered by the at least one object based on a vote by each classifier in said plurality of classifiers.

8. A post-detection processing system in accordance with claim 7 wherein each classifier is configured to use at least one feature in the plurality of features to provide a vote on the alarm status for each alarm, each vote comprising one of a true-false choice, a weighted value, and a probability.

9. A post-detection processing system in accordance with claim 7 wherein said post-detection processing system is further configured to combine the vote of each classifier to determine the alarm status for each alarm.

10. A post-detection processing system in accordance with claim 8 wherein said post-detection processing system is further configured to combine weighted value votes when each vote comprises the weighted value.

11. A post-detection processing system in accordance with claim 7 wherein said post-detection processing system is further configured to clear an alarm as being a false alarm based on a minimum number of votes provided by said plurality of classifiers.

12. A post-detection processing system in accordance with claim 11 wherein the minimum number of votes provided by said plurality of classifiers to clear an alarm is adjustable.

13. A post-detection processing system in accordance with claim 7 wherein said post-detection processing system is further configured to clear the container from further inspection based on a minimum number of cleared alarms.

14. A post-detection classification system for separating false alarms from true alarms by an imaging system, wherein an alarm is raised by the imaging system during a scan of a container, said post-detection classification system comprising at least one classifier configured to determine and issue a vote on a status of the alarm based on at least one calculated feature of a plurality of image elements within a plurality of images received from the imaging system, said at least one classifier constructed by:
collecting a test set including a true alarm subset and a false alarm subset;
calculating a first performance of said at least one classifier using the test set;
determining at least one of a range and a standard deviation for a plurality of features in the test set;
increasing a perturbation factor;
modifying a value of at least one feature of the plurality of features in the test set the modification based on the perturbation factor; and
calculating a second performance of said at least one classifier using the modified test set values.

15. A post-detection classification system in accordance with claim 14 wherein calculating a first performance of said at least one classifier further comprises determining for each subset a percent of true alarms retained and a percent of false alarms retained.

16. A post-detection classification system in accordance with claim 14 wherein modifying a value of at least one feature further comprises modifying a value of at least one feature by a random amount.

17. A post-detection classification system in accordance with claim 14 wherein modifying a value of at least one feature further comprises modifying a value of at least one feature by an amount between 0 and an amount determined by multiplying the perturbation factor by the standard deviation for the at least one feature.

18. A post-detection classification system in accordance with claim 14 wherein modifying a value of at least one feature further comprises modifying a value for a portion of the plurality of features.

19. A post-detection classification system in accordance with claim 14 wherein modifying a value of at least one feature further comprises modifying a value of each feature by a different amount.

20. A post-detection classification system in accordance with claim 14 wherein modifying a value of at least one feature further comprises restricting a modified value to a predetermined range.
